(19) United States
(12) Patent Application Publication
(10) Pub. No.: US 2006/0053076 A1
(43) Pub. Date: Mar. 9, 2006

(54) Monetizing time-sensitive content on network-connected media

(76) Inventor: Gary Kremen, Santa Fe, CA (US)

Correspondence Address: PERKINS COIE LLP, P.O. BOX 2168, MENLO PARK, CA, 94026, US

(21) Appl. No.: 10/938,122

(22) Filed: Sep. 10, 2004

Related U.S. Application Data
(60) Provisional application No. 60/607,212, filed on Sep. 3, 2004.

(51) Int. Cl. G06F 17/60

(52) U.S. Cl. 705/51

(57) ABSTRACT

Distribution and monetization of classified advertising, classifieds on network-connected media, online classifieds, any advertising on electronic displays such as advertising via electronic bill boards, (collectively “eclassifieds”) using techniques for more timely and wider exposure of time-sensitive content on online networks. Such techniques include using XML feeds and are based on the type of search engine involved, the geo-location of the web-surfer, the demographic and psychographic profile of the web surfer, and bandwidth requirements of the web-surfer.

### CROSS-REFERENCE TO RELATED APPLICATION

The present application claims the benefit of pending U.S. Provisional Application No. ______, filed Sep. 3, 2004, by Gary Kremen and is incorporated herein in its entirety by reference.

### TECHNICAL FIELD

The invention relates to the monetization and/or distribution of classified advertising, classifieds on network-connected media, online classifieds, any advertising on electronic displays such as advertising via electronic bill boards, (collectively “eclassifieds”) using techniques for more timely and wider exposure of time-sensitive content on online networks. Such techniques include using XML feeds and are based on the type of search engine involved, the geo-location of the web-surfer, the demographic and psychographic profile of the web surfer, and bandwidth requirements of the web-surfer. The distribution of eclassifieds include methods for converting the taxonomy of eclassifieds into a suitable taxonomy for pushing the eclassifieds as XML feeds, or data dumps or other similar formats into a number of different search engines, directories and the like (collectively “search engines”).

### BACKGROUND

The trend in online advertising is the increasing exchange of advertising related information between pay-per-click (PPC) advertisements and the advertising results served up by search engines. Search engines such as Google, AltaVista and Yahoo produce free results from search phrase queries that are displayed prominently for the web surfer, usually in the middle of the results page. Most of the time these free results are preceded by, surrounded by, intermixed with, or even followed by paid text results and/or banner advertisements. These paid results are likely using either CPA (cost per action), CPM (cost per thousand), or PPC (pay per click) financial models. Advertisers, not surfers, pay for the “paid” results. Thus search engines are “free.”

In the context of online advertising and paid results, how does eclassifieds fit in? Currently, eclassifieds very rarely, if at all, appear in paid results served up by search engines.

To explain, electronic classifieds (“eclassifieds”) are simply classifieds available online via the Internet or World Wide Web (“web”), or on any network-connected media or electronic displays. In general, eclassifieds are electronic representations of classifieds formatted for newspaper, magazine, or other print publication. Eclassifieds are typically posted on the web via online versions of print publications, such as Rich Media, etc. The typical eclassified advertisement represents a unique offer, wherein the underlying content likely changes frequently.

As will be appreciated, the underlying classified content may change for a variety of reasons such as a) a sale of the advertised product, b) a decision not to sell, c) a temporary withdrawal from the market as the advertiser negotiates, changes price or other details of the sale, or d) other reasons. Hence, eclassifieds are extremely time sensitive, extremely short-lived and are of little use to anyone unless found by potential web surfers in a very timely fashion.

Rather than directly accessing eclassifieds via their original source (e.g., online versions of print publication, etc.), the typical web surfer uses one or more search engines to access classifieds. This occurs for several reasons. One reason is that the typical web-surfer uses one or more search engines to access classifieds. First, the web surfer might not know any or all of the electronic addresses (URLs) of publications that might have items of interest. “Items of interest” may include both “sell an item(s)” and “buy an item(s).”

Second, the market has moved away from local, and regional newspapers online and other online sources of classifieds for news in general to national sources (such as http:/www.cnn.com or http://www.yahoo.com). Thus, web surfers are less familiar with the online local and regional newspapers because the surfers are more likely to read the non-electronic versions of the local and regional newspapers, if at all.

Third, online classifieds are harder to search because such searches are more structured due to the rigid nomenclature of the classifieds. The rigid nomenclature, while more accurate, is harder to use as each category has its own nomenclature or structured content. Search engines usually do not perform better with structured content.

Notwithstanding the myriad reasons in favor of having eclassifieds appear in paid results served up by search engines, the problem remains that eclassifieds do not appear in paid results because there are currently no adequate mechanisms for achieving such a goal.

Further, indexing of eclassifieds is not viable because there are no web pages associated with an eclassified, which can be indexed. Even if indexing is viable, search engines, because of the overwhelming amount of content on the Internet, suffer from the well-known and persistent problem of long latency between the introduction of new or modified content to the web and the indexing of such content by the search engine. This latency period may extend from days to months (e.g., Google® currently has about a six-week latency period), by which point digital content such as eclassifieds is often irrelevant. At the extreme of irrelevancy, the eclassified may no longer exist on the publisher's or newspaper's sites. For example, the formatting of the pointers to the eclassifieds, or the link pointing to the digital content may no longer function. In some cases, the results of the indexing (which might be more than three months old) are cached. However such cached content is usually useless because of its age.

As described below in greater detail, the lack of cooperation between eclassified providers and search engine providers are primary causes for the failure of search engines to present desired eclassifieds in a meaningful and timely manner to web surfers.

Search engines such as Google and AlITheWeb use numerous different techniques to locate and prioritize content. As a result, there is no single eclassified content format that is ideal for exposure to all search engines. Thus, inconsistency among search engine algorithms creates a wall between digital classified content providers and their intended audience.

To further exacerbate the difficulties experienced by the web surfer and the eclassified distributor, providers and/or distributors of eclassifieds often view search engine providers as competitors, and vice versa. This is particularly true in the areas of branding and customer retention. Newspapers and other traditional classifieds providers perceive Google, Yahoo and other portals as competition. This competition detracts from meaningful cooperation between eclassified distributors and search portals, which in turn makes it more difficult for the web surfer to uncover meaningful content.

Because eclassifieds are more difficult to successfully use through use of search engines, eclassifieds achieve less than their full potential value. As a result, the value of eclassifieds is diminished from their optimum value.

These and other issues are addressed by the invention as described herein.

### BRIEF DESCRIPTION OF THE DRAWINGS

FIG. 1A illustrates some high-level aspects of certain embodiments of the invention.

FIG. 1B illustrates a network diagram for the communication of digital text by a user to a conversion engine, according to embodiments of the invention.

FIG. 2 is a flow chart illustrating a third party aggregator method in accordance with one embodiment of the invention.

FIG. 3 is a flow chart of a method for converting digital content such as an eclassified file into a push format in accordance with another aspect of the invention.

FIG. 4 is a data structure for use with one push format of the invention.

FIG. 5 is a flow chart illustrating a method for retrieving pertinent data from an eclassified data record of a non-push format

FIG. 6 is a flow chart illustrating a method for preparing pertinent data into push format together with supporting data structures.

FIG. 7 is an example eclassified having a format derived directly from a print classified.

FIG. 8 illustrates a reformatted version of the eclassified of FIG. 7 in accordance with one embodiment of the invention.

### DETAILED DESCRIPTION

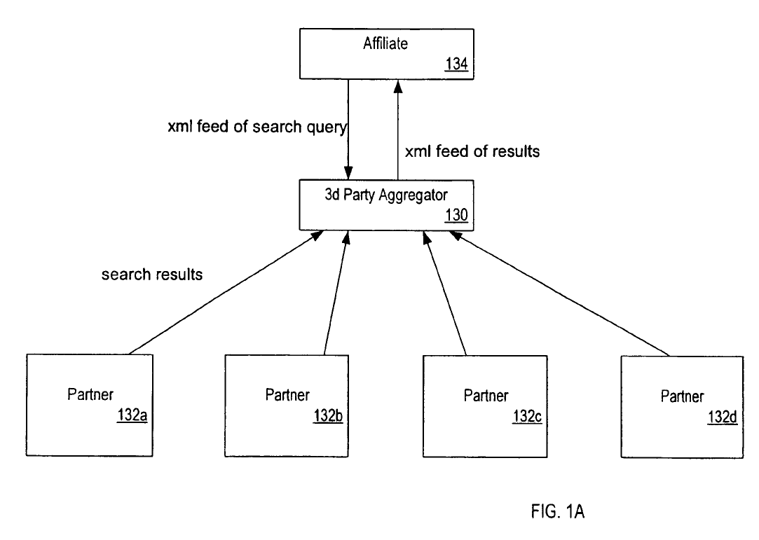

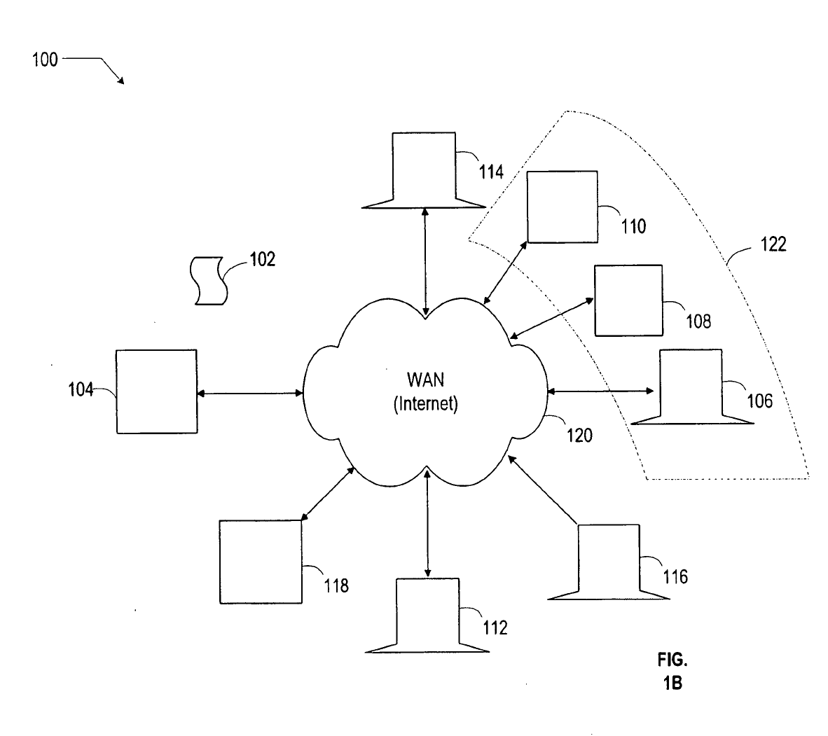

FIG. 1A illustrates some high-level aspects of certain embodiments of the invention. In FIG. 1A, a third party aggregator 130 forms partnerships with a plurality of search engine providers 134 (only one of which is shown in FIG. 1A) and a plurality of sources 132a-d of time-sensitive content (e.g., the eclassified distributors) for purposes of monetizing the time-sensitive content. The plurality of search engine providers are also referred to herein as affiliates. The third party aggregator is also referred to herein as an exchange. The plurality of sources of time sensitive content are also referred to herein as partners. The term “partnership” refers to a business relationship and is not restricted to any particular type of business relationship, and thus may vary from implementation to implementation.

An affiliate is a site where the web surfer types in his search query. Partners are sources of paid advertisements. While many search engines have their own advertising listings, search engines are in the business of providing their paid listings to other search engines. In such a context, search engines are partner sites. Thus, a search engine may either be an affiliate or a partner site, depending on where the web surfer enters the search query. An exchange is an entity that is an intermediary between affiliates and other partners of the exchange.

To illustrate by way of example, according to certain embodiments, assume that a web surfer types in a search phrase on an affiliate site. The affiliate site converts the search phrase into a real-time XML query feed 133. First, the affiliate may query the affiliate's own internal advertising base or the affiliate's own partners' sites in an attempt to satisfy the web surfer's search query. The affiliate site then pushes the search query XML feed 133 to the third party aggregator 130. The third party aggregator 130 attempts to find content in the third party aggregator's databases that satisfies the search query. If none of the third party aggregator's databases contain any content that satisfies the search query, then the third party aggregator will pull content that satisfies the search query from one or more sources 132a-b (i.e., partner sites). The content that satisfies the search query is herein referred to as search results. When the third party obtains the search results, either from querying its own databases or by pulling search results from one or more sources 132a-b, the third party aggregator converts the search results into an XML search results feed 136. The third party aggregator then pushes the XML search results feed 136 to affiliate 134 to satisfy the web surfer's search query. It is to be noted that the elapsed time starting when the web surfer enters the search query up to the time when the web surfer sees the results displayed on the affiliate site is a fraction of a second. The complex manner in which the web surfer's search query is satisfied is performed seamlessly and is completely transparent to the web surfer. Thus, the web surfer is provided a positive surfing experience.

The XML feed in push format may take a variety of forms and may vary from implementation to implementation. According to certain embodiments, the push format may include a title element, a keyword search element, a description element, a support URL element, an IP address, and a monetization URL element. The XML feed may also include information such as the geo-location of the web-surfer, the demographic and psychographic profile of the web surfer, and bandwidth requirements of the web-surfer. Such information can be used to tailor the search results for the web surfer. An example of an XML query is:
http://xml.kanoodle.com/xml.php?Terms=“surfing in San Diego”&strict=1&Hits_Per_Page=10&IP=209.81.7.23&affiliate=www.galaxyse arch.com

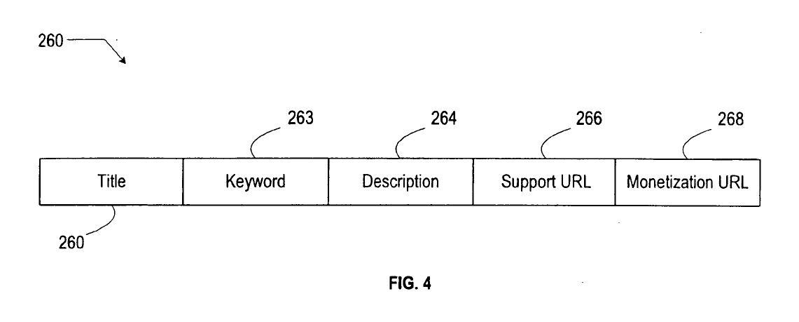

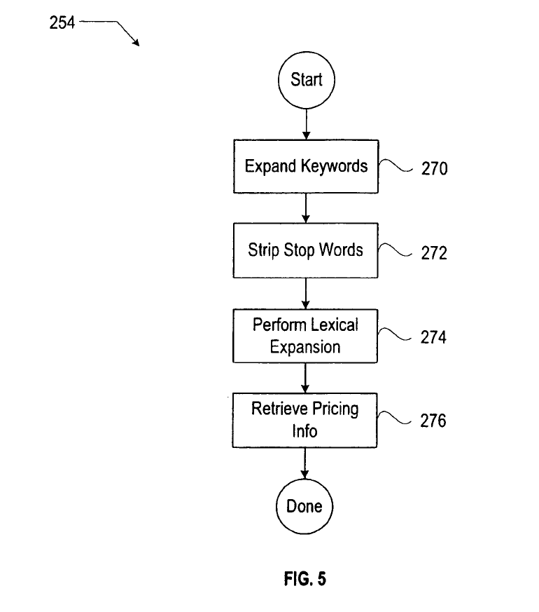

The XML push format is described in greater detail herein with reference to FIG. 4 and FIG. 5. According to certain embodiments, data dumps or FTP may used instead of XML.

When the affiliate site receives the XML search results feed, the affiliate sorts the listings in the search results. The listings in the search results that generate the most profit for the affiliate are displayed most prominently. To illustrate, assume for example, if a surfer types in “Surfing in San Diego” at http://www.Kanoodle.Com, Kanoodle might only have three listings starting at $0.06 and going to $0.04. In this case, Kanoodle will likely query its partners with this search term. Assume that GalaxySearch is one of these partners. Further assume that GalaxySearch only has two of its own paid listings for “Surfing in San Diego”—one at $0.20 and another at $0.06. Assuming a 60% revenue share arrangement with Kanoodle, Kanoodle will list the GalaxySearch listing at $0.12 (60%*$0.20) return first, then its own listing at $0.06, $0.05 and $0.04 in the second, third and fourth positions, and finally a GalaxySearch listing at $0.036 (60% * $0.06). As part of GalaxySearch's list finding process, GalaxySearch might also query its own set of proprietary partners (other than Kanoodle to prevent loops) looking for “Surfing in San Diego.” If paid listings are found and a “time out” has not occurred, the listings from GalaxySearch's partners will be sent to GalaxySearch at the revenue share arrangement between GalaxySearch and its partners. Then those results from the partner and GalaxySearch's own results are sent to Kanoodle. At this point, Kanoodle sorts all the results by the net revenue that Kanoodle would make and displays the results accordingly.

Further, the third party aggregator is adapted to perform fraud checks on the search results before the results are pushed to the affiliates. Fraud checks include checking the results for accuracy and legality. For example, no child pornography material will be allowed to pass through. As another example, checks are made to ensure that a click is made by a human searcher rather than a robot.

Thus, the third party aggregator can satisfy, for both affiliates and web surfers, the priorities that include: 1) relevancy of results; and b) speed of results; and c) results displayed correctly on their browser.

To reiterate, the partnerships allow the third party aggregator to:

1) gather the time-sensitive content 136a-b;

2) process the time-sensitive content to form customized formatted content 138; and

3) feed the customized formatted content directly to the plurality of search engine providers 134a-c (affiliates) in the partnership.

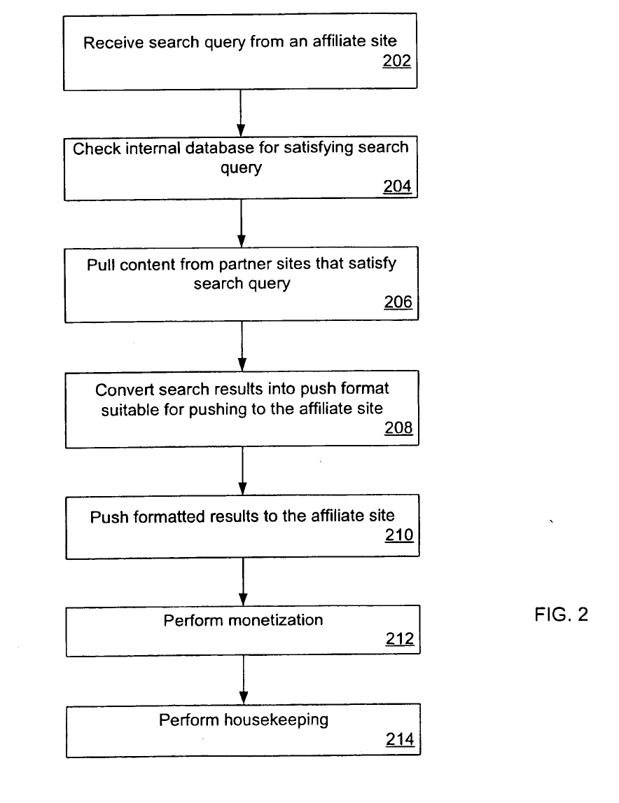

The processing of the time-sensitive content to form customized formatted content is described in greater detain herein with reference to FIGS. 2-8. New time-sensitive content and any updates are pulled in real-time from the plurality of partner sites to the third party aggregator site for processing into customized formatted content. The customized formatted content is stored in a database, according to certain embodiments.

The third party aggregator attracts search engine providers (affiliates) into the partnership by performing one or more of the following:

1) providing time-sensitive content to the search engine providers (affiliates) that the search engine providers would otherwise not obtain without a great deal of effort;

2) providing a fruitful experience to web surfers who use the search engines of the search engine providers in the partnership by giving the web surfers rapid and relevant search results in response to queries for time-sensitive content. Thus, the traffic is increased at the search engine providers' sites;

3) providing clean listings by checking for accuracy and legality;

4) increasing the value and prices that the affiliates can charge for advertising space because of increased traffic at their sites;

5) associating with a highly profitable anchor e-business that earns a substantially large market revenue in order to increase traffic for the affiliates;

6) sharing revenue obtained from monetizing the time-sensitive content with the affiliates;

7) providing transparency in accounting; and

8) providing fraud accounting protection.

The third party aggregator attracts providers of time-sensitive content (partner sites) into the partnership by performing one or more of the following:

1) providing a one-stop service for feeding the partner's time-sensitive content to some or all of the affiliates;

2) providing an upsell to the originator (e.g., advertiser of the e-classified) of the time-sensitive content when the originator submits his e-classified to partner sites;

3) providing branding for the partner sites by a) linking the web-surfer directly to the partner's landing site, b) including the partner's logo as part of the search results listing or at premium advertising spaces at affiliate sites;

4) providing a conduit for pushing the time-sensitive content to international affiliates;

5) increasing high quality traffic for the partner sites;

6) increasing the prices that the partners can charge for advertising space because of the increased high quality traffic;

7) providing transparency in accounting; and

8) providing fraud accounting protection.

Payment to the third party aggregator may come from the originator of the time-sensitive content, or the partners. The third party aggregator may then share the revenue with the affiliates. The search engine providers may share in the revenue based on at least one payment method selected from a group comprising: 1) cost per thousand impressions (CPM); 2) pay-per-click (PPC); and 3) fixed fee.

Further, certain embodiments teach a variety of mechanisms for generating and reformatting time-sensitive digital content for maximum exposure on the connected networked media, such as the Internet. Such mechanisms include those by which digital content is properly formatted and pushed out to the and thus displayed substantially immediately by search engines as paid results (PPC, for example). Other aspects include mechanisms for ensuring digital content is featured prominently on web sites of search engine providers. For example, in certain embodiments, there are mechanisms by which a search for eclassifieds results in relevant text listings, banners, pop up windows, pop up under exit consoles, etc.

As an illustrative, non-limiting example, the time-sensitive content may take the form of an eclassified. The original content may be submitted by a user via legacy newspaper storage systems, converted to an eclassified, or electronic forms and/or via a web interface, and this text may subsequently be reformatted by applications, local processes, or other software. Such software may be configured to reformat the content into a form suitable for direct feeding to search sites in response to a search query.

As will be appreciated, embodiments of the invention can be responsive to digital content in any available format. Typical formats used for digital content in this context include plain text, such as ASCII, encoded markup languages such as HTML, and specialized encoding languages such as those used by eclassified providers and newspaper production systems. In some embodiments, the content may be customized for particular search engines, such that the content is featured prominently by such search engines when certain search terms are presented to the search engine. These and other embodiments are described in greater detail infra.

The invention includes embodiments particularly suited for timely digital content, which loses relevance over time. Given the time-sensitivity of the content, immediate access of such materials by web surfers are imperative to the content holder, and the invention supports automated techniques for reformatting and distributing such content to address these requirements.

An exemplar of such time-sensitive content is presented by eclassified advertisements. Typically, Internet-based eclassifieds are posted to sites supporting such ads, and these type of advertisements are rarely indexed by search engines, if at all, in a timely fashion. Moreover, such advertisements are often lost in a myriad of search results offered by typical search sites. As will be appreciated by those skilled in the art, eclassifieds are but one example of such time-sensitive content, any many other examples shall be readily apparent to one skilled in the relevant arts.

FIG. 1B schematically illustrates a network architecture 100 that may be used by embodiments of the invention. The network architecture 100 includes time-sensitive digital content 102, a web surfer computer 104, a format engine 106, a push engine 108, a monetization engine 110, search engines 112 and 114, and an eclassified website 116, and an online newspaper website 118, all coupled bi-directionally through a wide area network (WAN) such as the Internet 120.

A advertiser through a variety of mechanisms may submit the time-sensitive digital content 100, such as an eclassified. These input mechanisms include a form presented via a web interface, legacy eclassified advertisement production systems, and third party eclassified brokers. These input mechanisms are made available to the advertiser through the advertiser computer 104. The data is then stored as digital content in any suitable format, and then made available over the web through a source such as the eclassified website 116 or the online newspaper website 118. Typical formats for storing digital content in this context include plain text format as entered by the advertiser, such as ASCII, encoded markup languages such as HTML, and specialized encoding languages such as those used by eclassified providers and newspaper production systems.

The format engine 106 is operable to convert the digital content, as input by the advertiser or as formatted by the eclassified provider/distributor, into a specified “push” format well suited for direct feeding, by XML feed for example, to search engines such as search engines 112 and 114, in response to a search query by a web surfer.

The push engine 108 operates on the push formatted digital content so that such content can be directly fed to search engines, such as search engines 106 108, in response to search queries submitted on the search engine sites. The push engine 108 may be further operable to present the digital content to the search engines such that the digital content is featured prominently when certain search terms are presented to the search engine.

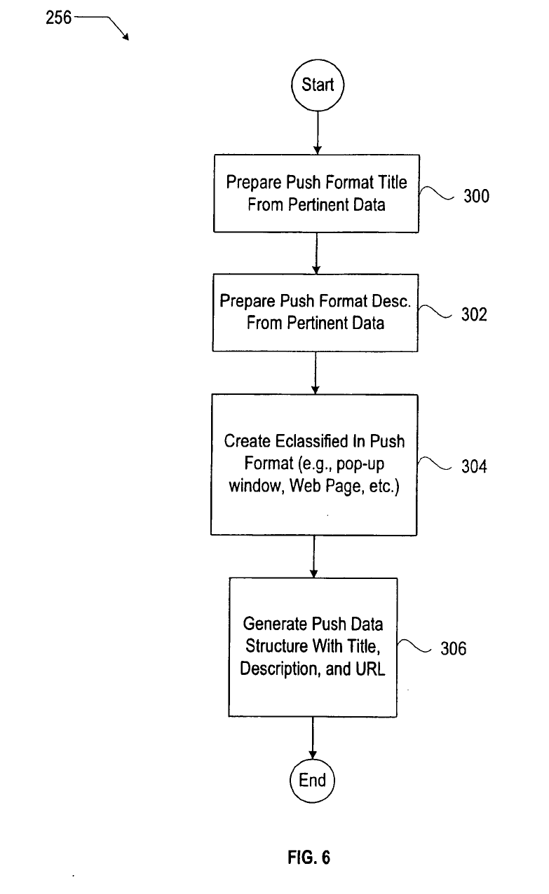

The monetization engine 110 attends to any necessary accounting associated with the format and push processes. As will be appreciated, the service of formatting and pushing digital content into search engine indexes for prominent display can readily be monetized by any third party aggregator providing these services. Payment for these services may come directly from the advertiser. More likely, eclassified distributors (partner sites) will pay the third party for distribution of large blocks of eclassifieds, the cost of this being passed onto the advertiser indirectly either hidden in the basic advertising cost or as an extra feature. Third party aggregators will be described below in more detail with reference to FIG. 6.

According to certain embodiments, a third party aggregator acts as an independent service provider implementing certain aspects of some embodiments on a global scale. One method for implementing a third party aggregator is described in more detail below with reference to FIG. 6. A third party aggregator would receive the eclassified data in any format used by the eclassified provider, attend to reformatting into a push format, push the digital content into the search engines, and attend to monetization of the transaction. With reference to FIG. 1B, this includes the functionality of the format engine 106, the push engine 108, and the monetization engine 110. In some embodiments, these three engines will be found on a single third party aggregator server 122 indicated by the hashed lines. Alternatively, these services could be distributed across the Internet 120.

FIG. 2 illustrates a flow chart of a method 200 for a third party aggregator to perform a push and format operation on digital content in accordance with one embodiment of the invention. The third party aggregator may be implemented as an application instantiated on a server computer coupled to the Internet. Alternatively, portions of the third party aggregator may be distributed across various servers coupled directly or indirectly to the Internet. One possible set of processes for implementing a third party aggregator is described above with reference to FIG. 1B.

The method 200 begins in a step 202 where the third party aggregator receives a search query form an affiliate site. According to one embodiment, the search query is in the form of an XML feed. At step 204, the third party aggregator checks the third party aggregator's internal database for search results that will satisfy the search query. If the third party aggregator does not find such search results, at step 206, the third party aggregator then attempts to pull such content from partner sites.

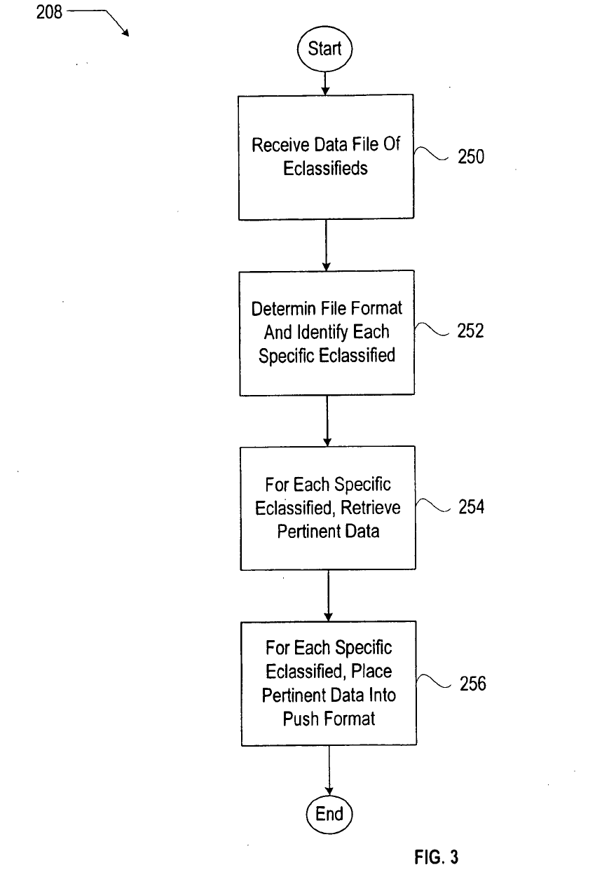

In a step 208, the third party aggregator converts the digital content into the requested push format. The push format may take on a variety of forms. For example, certain embodiments contemplate generating title, description, and URL elements. The push format may include other elements such as IP address information element, and key word search element. The data found at the linking URL might provide a web page, a pop up window, or perhaps the URL indirects to the original source of the eclassified or some data. One method for generating push formatted eclassifieds is described below in more detail with reference to FIG. 3, and one data structure for use in push formatting is described below with reference to FIG. 4.

In a step 210, the third party aggregator pushes the formatted search results to the affiliate site that sent the search query to the third party aggregator. At this point the substantive portion of the transaction has been completed. In a step 212, the third party aggregator monetizes the successfully completed transaction. Monetization may take on a variety of forms. For example, the third party aggregator may perform account management for revenue sharing in the event the web surfer clicks through to the ecclassied (in a PPC model). Alternatively, the third party aggregator may update a database for periodic billing, or update of a database for later accounting.

After the monetization step 212, the third party aggregator performs any necessary housekeeping functions. For example, in some embodiments usage statistics are maintained in a third party aggregator database. Additionally, a receipt and other transaction information may be transmitted to affiliates and partners.

Turning next to FIG. 3, an eclassified conversion method 208 in accordance with one embodiment of the invention will now be described. The format conversion method 208 is one suitable embodiment for implementing the step 208 of FIG. 2 when the digital content intended for push formatting is an eclassified file.

A step 250 pulls a data file of eclassifieds in a format specified by the third party aggregator client. A step 252 determines the format of the eclassified data file in order to properly parse and format the file. A step 254 retrieves pertinent data from each eclassified present in the eclassified file. This data will include pricing, product or service, source of origin of the eclassified, contact data, etc. One suitable method for implementing step 254 is described below in more detail with reference to FIG. 5.

Continuing with FIG. 3, a next step 256 places the retrieved pertinent data into the specified push format together with any supporting data structures, for each retrieved classified. One suitable push format is a data structure 260 as shown in FIG. 4, and described immediately below. One suitable method for implementing step 256 is described below in more detail with reference to FIG. 6. After step 256, the method 208 is complete.

FIG. 4 illustrates one suitable push format data structure 260. The push format data structure 260 includes a title element 262, a keyword element 263, a description element 264, a support URL element 266, and a monetization URL element 268. The title element 262 is for storing an eclassified title that would be meaningful to the web surfer. The keyword element 263 is for storing keywords stripped and/or generated from the eclassified. The description element 264 is for storing a narrative of the eclassified aimed at the web surfer. The support URL element 266 is for storing an indirection to a supporting data structure such as a pop up window or web page providing additional information regarding the eclassified, or may indirect directly to the eclassified web site provider. The monetization URL element 268 is for storing an indirection used for billing of an end search engine and potential intermediate search engines. As will be appreciated, data structures according to other embodiments may be arranged differently and have additional or fewer elements.

FIG. 5 illustrates a flow chart of a method 254 for retrieving pertinent data from an eclassified file not yet placed into a push format. A step 268 retrieves a data record for a single eclassified add found in the eclassified file. A step 270 expands all keywords found in the data record. For example, many phrases in the eclassified context are typically represented through established acronyms such as OBO for “or best offer.” Expanding of these words renders the text more meaningful for later formatting. A next step 272 removes stop words (“a,” “the,” “if” etc.). A step 274 performs lexical expansion in a manner that will provide a more meaningful search later. For example, the term “car” may be expanded into the set “car, cars, auto, autos, automobile, automobiles” etc. A final step 276 retrieves pricing information. As will be appreciated, other information may be relevant depending upon the format and requirements of specific search engines. The data retrieval steps of FIG. 5 simply provide one example from which the skilled artisan may readily extrapolate.

FIG. 6 is a flow chart illustrating a method 256 for formatting the retrieved data into a push format in accordance with certain embodiments. A step 300 prepares a text title from the retrieved eclassified data. A step 302 prepares a text description from the retrieved eclassified data. A step 304 creates a supporting data structure for use with an eclassified data record made from the formatted and retrieved data. Possible data structures include a related pop up window and a web page. A step 306 then creates a data record 260 as illustrated in FIG. 4, with a URL 266 pointing to the supporting data structure.

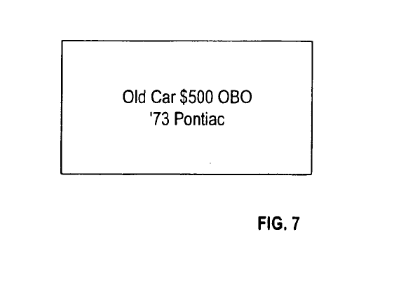

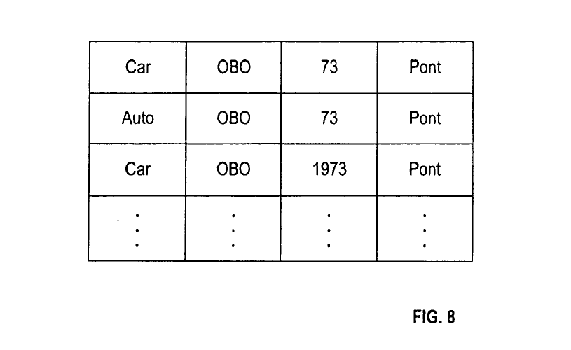

With reference to FIGS. 7-8, one particular example will now be provided. FIG. 7 illustrates data found in an eclassified derived from a classified for a 1973 Pontiac originally found in a newspaper. Following the techniques described above, the keywords and data from FIG. 7 are expanded into a data structure such as shown in FIG. 8. FIG. 8 provides a wide variety of expressions for the underlying content of FIG. 7. As will be appreciated, this format allows for increasing the likelihood of this eclassified being present in a relevant way in a related search.

In embodiments of the invention, the conversion engine may be resident on servers 104 remote from the user entering the text of the eclassified ad. In some such embodiments, the conversion engine is in communication with the user via a web browser linked to the servers operating the conversion engine via HTTP, or an equivalent networking protocol. As a non-limiting example, the engine may be triggered by a Common Gateway Interface (CGI) daemon engaged after receipt of user commands at a server remotely linked to the user. In alternative embodiments, the conversion engine may be a process at least partially resident on a terminal 102 employed by the user for entry of the text of the eclassified ad. By way of non-limiting example, the conversion engine may be at least partially contained as an executable on a web browser, such as a plug-in. Alternatively, the conversion engine may operate locally to the user, in the form of a scripting language such as JavaScript® of Sun Microsystems of Palo Alto, Calif.

Upon conversion, the advertisement is encoded in a markup language in a specialized format. The markup language may include HTML, XML, SGML, or other markup language. The conversion engine may include separate customizations targeted to distinct search engines.

Note that the algorithms and techniques described above are for illustrative purposes only, and many alternatives shall be apparent to those skilled in the art. In particular, those skilled in the art shall recognize that eclassifieds are but one example of time-sensitive content whose exposure can be maximized by the techniques described herein. The invention is equally applicable to any other sort of time sensitive content, illustrative, non-limiting examples of which include public notices, news articles, and myriad other examples that shall be apparent to those skilled in the art.

What is claimed is:

1. A method of monetizing time-sensitive content, the method comprising:
partnering with a plurality of search engine providers for providing a one-stop service to a plurality of providers of the time-sensitive content for increasing a value of the time-sensitive content by directly feeding the time-sensitive content to one or more search engines associated with the plurality of search engine providers in a manner responsive to queries submitted to the one or more search engines.

2. A method of monetizing time-sensitive content, the method comprising:
partnering with a plurality of search engine providers;
partnering with a plurality of providers of the time-sensitive content;
transforming the time-sensitive content into a customized formatted content that is suitable for directly feeding to one or more search engines associated with the plurality of search engine providers;
feeding the customized formatted content to the one or more search engines;
and
receiving revenue from one or more entities selected from a group comprising:
the plurality of providers of the time-sensitive content;
customers who pay the plurality of providers of the time-sensitive content to publish the time-sensitive content.

3. The method of claim 1, wherein the time-sensitive content is an eclassified.

4. The method of claim 1, further comprises featuring the time-sensitive content in advertisement spaces or sponsored listing spaces of web sites associated with the one or more search engines in response to queries for the time-sensitive content submitted to the one or more search engines.

5. The method of claim 1, wherein the act of partnering with a plurality of search engine providers for providing a one-stop service to a plurality of providers the time-sensitive content is performed by a third party aggregator.

6. The method of claim 1, further comprising receiving revenue from one or more entities selected from a group comprising:
the plurality of providers of the time-sensitive content;
customers who pay the plurality of providers of the time-sensitive content to publish the time-sensitive content.

7. The method of claim 6, wherein receiving revenue is based on at least one payment method selected from a group comprising:
cost per thousand impressions (CPM);
pay-per-click (PPC); and
fixed fee.

8. The method of claim 1, wherein the one-stop service includes providing branding for each of the plurality of providers of the time-sensitive content.

9. The method of claim 1, wherein the one-stop service includes partnering with international search engine providers to increase exposure of the time-sensitive content.

10. The method of claim 1, wherein the one-stop service includes providing transparency in cost or revenue accounting by providing detailed information of the cost or revenue accounting to the plurality of providers of the time-sensitive content.

11. The method of claim 1, wherein the one-stop service includes providing a user-friendly API to the plurality of providers of the time-sensitive content for submission of the time-sensitive content for processing for subsequent feeding to the one or more search engines

12. The method of claim 1, wherein partnering with the plurality of search engine providers includes revenue sharing with the plurality of search engine providers.

13. The method of claim 12, wherein the revenue sharing with the plurality of search engine providers is based on at least payment method selected from a group comprising:
cost per thousand impressions (CPM);
pay-per-click (PPC); and
fixed fee.

14. The method of claim 1, wherein partnering with the plurality of search engine providers includes providing transparency in revenue sharing accounting by providing detailed information of the revenue sharing accounting to the plurality of search engine providers.

15. The method of claim 13, wherein partnering with the plurality of search engine providers includes using an anchor e-business with a book advertising business that earns a substantially large market revenue for attracting the plurality of search engine providers into partnership.

16. The method of claim 1, wherein feeding the time-sensitive content to the one or more search engines includes transforming the time-sensitive content into one or more customized formatted content that is suitable for direct feeding to the one or more search engines.

17. The method of claim 16, wherein feeding the time-sensitive content to the one or more search engines includes maintaining a database for storing the one or more customized formatted content.

18. The method of claim 17, wherein feeding the time-sensitive content to the one or more search engines includes automatically updating the database in real-time in response to new time-sensitive content.

19. The method of claim 16, wherein feeding the time-sensitive content to the one or more search engines includes screening the time-sensitive content to provide fraud accounting protection.

20. The method of claim 16, wherein the customized formatted content are suitable for producing geo-targeted search results corresponding to a geo-location of a search query.

21. The method of 16, wherein transforming the time-sensitive content further comprises:
receiving a digital text corresponding to the time-sensitive content by one or more computer processes;
upon receiving the digital text, reformatting the digital text into the one or more customized formatted content, the customized formatted content being encoded in at least one markup language for direct feeding to the one or more search engines.

22. The method of claim 21, wherein each of the one or more customized formatted content is customized for a distinct search engine from the one or more search engines.

23. The method of claim 21, wherein the at least one markup language includes HTML.

24. The method of claim 21, wherein the at least one markup language includes XML.

25. The method of claim 21, wherein the at least one markup language includes SGML.

26. The method of claim 21, wherein reformatting the digital text further includes inserting one or more meta-tags in the digital text.

27. The method of claim 26, wherein the reformatting the digital text further includes selecting one or more keywords for the digital text.

28. The method of claim 27, wherein the selected one or more keywords are inserted in the reformatted digital text.

29. The method of claim 27, wherein the one or more meta-tags include the one or more keywords for the digital text.

30. The method of claim 26, wherein the reformatting the digital text further includes generating a descriptive title for insertion in the digital text.

31. The method of claim 21, further includes making changes in a customization procedure for reflecting evolving push format used by the one or more search engines.

34. The method of claim 21, further comprising:
creating one or more supporting data structures for use in the reformatted digital text.

35. The method of claim 34, wherein the one or more supporting data structures include one or more elements from a set of elements, the set of elements comprising:
a title element;
a keyword element;
a description element;
a support URL element; and
a monetization URL element.

36. The method of claim 35, wherein:
the title element stores a title associated with the digital text, wherein the title would be meaningful to web-surfers;
the keyword element stores keywords associated with the digital text;
the description element stores a descriptive narrative associated with a content of the digital text, the narrative being such as to capture attention from web-surfers.;
the support URL element stores a first indirection to a pop-up window or web page that provides additional information associated with the digital text.; and
the monetization URL element stores a second indirection to information associated with billing of the one or more search engines.
